(19) United States
(12) Patent Application Publication
(10) Pub. No.: US 2026/0208050 A1
(43) Pub. Date: Jul. 23, 2026

(54) SYSTEMS AND METHODS FOR GENERATIVE CONTENT CRAFTING AND GENERATIVE ARTIFICIAL INTELLIGENCE (AI) CONTENT CRAFTING

(71) Applicant: Sony Interactive Entertainment INC., Tokyo (JP)

(72) Inventors: Charles McCoy, San Diego, CA (US); True Xiong, San Diego, CA (US)

(73) Assignee: Sony Interactive Entertainment INC., Tokyo (JP)

(21) Appl. No.: 19/034,488

(22) Filed: Jan. 22, 2025

(51) Int. Cl. A63F 13/67

(52) U.S. Cl. CPC A63F 13/67

(57) ABSTRACT

System, process, and device configurations are provided for generative content crafting for an electronic game. A method can include receiving at least one seed element including a user description of a game element to be generated and a user instruction for generation of a game element. The method can include controlling a machine model for crafted game element generation using the at least one seed element. Crafted game elements may be generated to create new elements of the game, such as tools, characters, objects, and backgrounds without deterministic crafting of objects wherein crafting is limited to a predefined combination of elements and predefined results. Multiple seed elements may be detected and used for content crafting. Seed elements can include at least one of text, audio, graphical, and video. Machine models may be controlled to generate craft elements based on color temperature, color pallet, time period, drawing style and game function.

### CROSS-REFERENCE TO RELATED APPLICATION

This application is concurrently filed with U.S. patent application Ser. No. ______ titled SYSTEMS AND METHODS FOR EVALUATING AND MANAGING CRAFTED ELEMENT OF ELECTRONIC GAMES, and U.S. patent application Ser. No. ______ titled SYSTEMS AND METHODS FOR CONTENT CREATION TOOLS AND CONTENT SOURCING, the specifications of which are hereby expressly incorporated by reference in their entirety.

### FIELD

The present disclosure is directed to interactive entertainment and electronic video gaming, including gaming device operations, processes, configurations, user interface control and control device configurations, and generative processes to create new content for electronic games and including machine generation of electronic game content.

### BACKGROUND

Computer and console games have been developed in many styles for different gaming systems and platforms. Games and content are often directed to different forms of game play and even different styles of controllable elements. One popular gaming style includes building or developing elements within a game. In this game style, and many game applications, operations are deterministic and based on preprogrammed elements for game play. There is a desire for use of generative applications and programs in games. Many existing generative elements are only graphical or textual and thus, are not configured for use with electronic gaming. There is a desire to provide generation of game elements and functions for users. There is also need and a desire for generative processes and systems with gaming systems to improve game functions and experiences of users.

### BRIEF SUMMARY OF THE EMBODIMENTS

Disclosed and described herein are systems, methods and configurations for generative content crafting for electronic games. In one embodiment, a method includes receiving, by a device, at least one seed element and a user instruction for generation of a game element, wherein the seed element includes a user description of a game element to be generated. The method includes controlling, by the device, a machine model for game element generation using the at least one seed element, wherein the machine model is controlled to generate a crafted game element. The method includes outputting, by the device, the crafted game element for the electronic game.

In one embodiment, the seed element includes at least one of text, audio, graphical, video and in game input, and wherein the seed element is received by the device.

In one embodiment, receiving at least one seed element includes receiving a plurality of seed elements, and wherein controlling the machine model includes generating the crafted game element based on at least one characteristic of each seed element.

In one embodiment, the user instruction identifies a game feature of the electronic game to be modified.

In one embodiment, machine model is controlled to generate at least one craft element using the seed element based on at least one of a color temperature, color pallet, time period, drawing style and game function.

In one embodiment, the machine model is controlled to generate a visual component of the generated craft element and a functional component of the generated craft element, and wherein the generated craft element is generated for use by the electronic game for presentation during game play.

In one embodiment, the machine model is controlled to use at least one game element template, the game element template selected based on the seed element and the game element template including at least one field description, wherein each field description of the template providing a characteristics for generating the crafted element.

In one embodiment, the machine model is controlled to generate at least one craft element using the seed element including detecting visual elements of the electronic game by the machine model, determining a visual style of the visual elements, generating a visual parameter for the craft element using the visual style determined by the machine model and applying at least one constraint to the crafted element.

In one embodiment, outputting the crafted game element includes presentation of the crafted game element during a session of the electronic game, and wherein presentation includes use of the crafted game element with the electronic game.

In one embodiment, the method includes clustering players in the electronic game based on at least one of use and characteristics of the crafted game element.

Another embodiment is directed to a device configured for generative content crafting for an electronic game. The device includes an interface and memory storing executable instructions and a controller, coupled to the interface and memory. The controller is configured to receive at least one seed element and a user instruction for generation of a game element, wherein the seed element includes a user description of a game element to be generated. The controller is also configured to control a machine model for game element generation using the at least one seed element, wherein the machine model is controlled to generate a crafted game element. The controller is also configured to output the crafted game element for the electronic game.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIGS. 1A-1B are graphical representations of generative content crafting for an electronic game according to one or more embodiments;

FIG. 2 illustrates a process for generative content crafting for an electronic game according to one or more embodiments;

FIG. 3 illustrates a graphical representation of a system and device for generative content crafting according to one or more embodiments;

FIG. 4 illustrates a graphical representation of generative content crafting according to one or more embodiments;

FIG. 5 illustrates a graphical representation of generative content crafting training according to one or more embodiments;

FIG. 6 illustrates a graphical representation of generative content crafting and player grouping according to one or more embodiments; and

FIG. 7 illustrates a process for evaluating crafted content according to one or more embodiments.

### DETAILED DESCRIPTION OF THE EXEMPLARY EMBODIMENTS

### Overview and Terminology

One aspect of the disclosure is directed to generative content crafting for electronic games and processes and operations for generative crafting. Embodiments are directed to gaming systems which may include consoles, processors or servers that generate game media. Embodiments may be performed by one or more network devices such as servers for providing, managing and hosting electronic games. Processes, system configurations and device configurations according to embodiments are provided to craft game elements, which can include one or more of a game tool (e.g., weapon, vehicle, armor, skin, etc.), game environment (e.g., background, landscape, mood lighting, location, etc.) game area, game character (e.g., player controlled, non-player controlled) and game element in general. Crafting as used herein may include generation of a game element and/or game feature based on user input. Crafting can include modifying an existing element of a game, generating an entirely new element of a game and using machine models for generation of game elements in response to a user input or instruction. Unlike generation of an image, processes and system configurations may be configured to generated game elements which require one or more of a visual representation, function within the game and game code to allow for use. Use of machine models may include use of artificial intelligence (AI) such as one or more of an AI engine, and generative AI content crafting.

Embodiments include operations and process to produce content from one or more seeds. Systems may receive and detect seed elements or seed content as input from a user. One or more forms of seed content may be detected an incorporated to generate crafted content. By way of example, a user may provide or identify image data including an image of an object and a user instruction to generate a game element (e.g., tool, weapon, character worn item, etc.) with an appearance of the provided image data. Similarly, a user may provide a text or spoken description of a game element to create. Seed elements may be detected as used as input, and processes described herein can utilize one or more seed elements.

Embodiments include operations and processes for content production to fit one or more aesthetics and or design styles of an electronic game including elements of an electronic game. Content crafting may utilize seeds as one factor and utilize electronic game data as a reference and/or constraint to generate crafted elements. As such one or more seed elements may be limited or modified based on a user response. For example a user command to generate a color of an element may be limited based on the detected color patterns and pallet of the electronic game when game elements are generated. Embodiments include operations and process to train one or more models based on in game elements to determine elements (visual) and configuration (functionality) for use in electronic games. In addition to the appearance of an element crafted content may include generating and/or modifying game code of an element to allow for use in a game. Content crafting may apply to one or more elements of an electronic game including player controlled elements, non-player controlled elements and game environments. Embodiments may also be configured to generate one or more features of game areas (e.g., levels, worlds, race tracks, landing displays, menus, interactive controls, etc.).

Embodiments are not limited to creating tools. Content crafting and drafting by a machine model as discussed herein may be used for generating electronic elements for a variety of applications.

One aspect of the disclosure is directed to evaluation of crafted element. Embodiments are directed to gaming systems which may include consoles, processors or servers that generate game media. According to embodiments, processes and device configurations may include evaluating crafted content of an electronic game. Game data may be received for an electronic game, instances of the crafted game element in the electronic game and user actions associated with the crafted game element. Electronic games and/or system data may include game data for at least one user of the electronic game. Processes can include detecting a crafted game element in the electronic game for at least one user of the game and performing at least one evaluation operation for the crafted game element by the at least one user of the game. Detecting a crafted game element includes detecting a number of instances a crafted game element is presented, and a number of user actions associated with the crafted game element. Processes can include outputting a determination of the at least one evaluation operation to assess the behavior of the crafted element. Based on the use of crafted element, including adoption of the element by users (or non-use), the element may be modified, deleted or exported for use outside of the game. Evaluation may be to allow users to customize elements for a game, prohibit elements that negatively impact game play and/or increase user experience with electronic games.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### Exemplary Embodiments

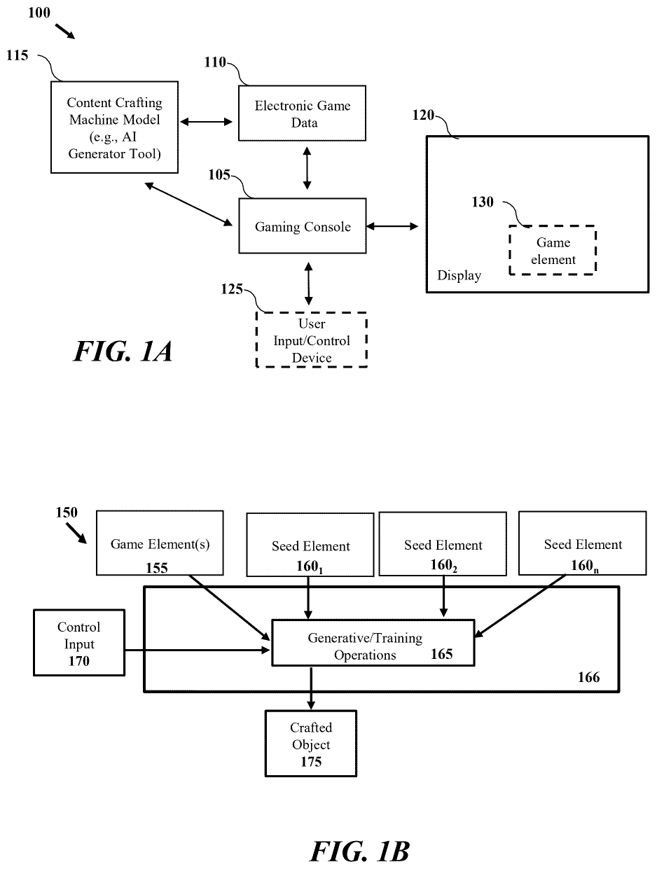

FIGS. 1A-1B are graphical representations of generative content crafting for an electronic game according to one or more embodiments. FIG. 1A illustrates system 100 for generative content crafting. According to embodiments, generative content crafting may be performed by at least on device for an electronic game. Content crafting may include generating one or more game elements, such as tools, characters, backgrounds, and game elements, for an electronic game and/or for use with one or more games. According to embodiments, content crafting may be based on one or more seed elements and user instructions. A seed element may include one or more items, such as game items user for crafting and/or uploading elements, in the form or images, test, words, and description provided by a user. Seed elements may be provided by a user and generation of a crafted element may be performed by one or more devices. Process 100 illustrates operations for generation of a crafted element. Processes described herein may include one or more operations performed by a machine model and/or artificial intelligence (AI) wherein machine processes generate one or more features of a game element based on user input, such as a seed input. FIG. 1B illustrates process 150 including one or more operations for generating a crafted object. Unlike deterministic crafting of objects wherein a predefined combination of in-game elements may be used as input to unlock or present a game item, crafted elements may be generated to include elements and/or features which are not predefined in an electronic game. System 100 may utilize one or more operations of process 150 for generative content crafting.

System 100 illustrates devices configured for generative content crafting. System 100 may include gaming console 105 configured to output game content for one or more electronic games, such as electronic game data 110. Electronic game data 110 may include game data including visual, audio and processing data for presentation of an electronic game title (e.g., video game, etc.). Gaming console 105 may be configured to receive electronic game data 110 and output game content to an output device, such as display 120. Display 120 may relate to an electronic display device (e.g., TV, monitor, etc.) and/or one or more user wearable devices, such as head worn display, augmented reality device, etc. Game data output by gaming console 105 may include one or more display elements, such as game element 130 presented by display 120. According to embodiments, gaming console 105 may be configured to receive user controls. When display 120 is integrated with gaming console 105, user input may be made to the gaming console directly. According to embodiments, gaming console 105 may receive user input from one or more user controllers (e.g., handheld game controllers), such as user optional input/control device 125.

According to embodiments, processes and device configurations are configured for generative content crafting, and one or more device may utilize a content crafting machine model 115 (e.g., AI generator tool) to generate crafted game elements. Content crafting machine model 115 may function as part of gaming console 105, electronic game data 110, and/or be a network device. According to embodiments, one or more seed elements may be used as an indication of a crafted game element to create. Using the seed elements, content crafting machine model 115 may generated a game element for electronic game data 110. As descried herein, the crafted game element may be a new element a user can use in a game. The crafted game element may be evaluated by the system, modified and exported for other users to user with the electronic game. Crafted game elements may relate to tools or weapons a user may use with one or more player controlled characters. Crafted game elements may relate to one or more modifications of game elements, such as skins or appearance or characters and game elements. Unlike selection of a display attribute or type for a game menu, crafted game elements may be generated for the electronic game and not be part of the underlying electronic game data when created. Crafted game elements may be generated to be include code and/or metadata such that electronic game data may use and display the item. Accordingly, crafted of game elements may include modification of game code and/or updating of electronic game data 110.

System 100 may be configured to use machine models and processes for generative output (e.g., generative AI) in a crafting system in a crafting system to enable the creation of new unique content. Crafting may be associated with one or more specific electronic games, and one or more specific electronic game environment. Embodiments also utilize one or more seed elements and detection and use of seed elements a user input for content crafting. Embodiments are provided for use of generative AI crafting for an in-game content crafting system, it should be known that the same crafting system can be used in other scenarios, such as a tool where the main goal is to use crafting to create new unique content for use outside of the tool.

According to embodiments, gaming console 105 may be configured to perform one or more user entertainment functions and is not limited to output of electronic gaming data. As such, gaming console 105 may relate to one or more interactive media players.

Process 150 of FIG. 1B illustrates generative content crafting. Process 150 may include operations performed by a content crafting machine model 115. Process 150 may be based on game elements 155 and one or more seed elements 160₁₋ₙ received. Game elements 155 may relate to one or more features of electronic game data including characters, color schemes, game environments, game type and game backgrounds. Seed elements 160₁₋ₙ may relate to one or more input parameters provided by a user for content crafting. Seed elements 160₁₋ₙ may each include a user description or characteristic of a game element to be generated. Seed elements 160₁₋ₙ may include at least one of text, audio, graphical, video and in game input. Seed elements 160₁₋ₙ may be used in combination with one or more of game element(s) 155 and control input 170 for generation of a game element.

According to embodiments, process 150 includes generative/training operations 165 which may include one or more of generative content crafting and training operations for generation of a crafted object 175. Process 150 may be performed by device 166 which may include one or more servers. Generative/training operations 165 can use seed elements 160₁₋ₙ as the basis for generation of a new piece of content for an electronic game. Seed elements 160₁₋ₙ can be in the form of items—such as in-game items used for the crafting or uploaded images, words—such as descriptions, or references to things. Process 150 may function similar to cross breading plants or animals to get a new variation with desired aspects from the parents. Generative/training operations 165 can be based on any number or type of seed elements. Generative/training operations 165 can include implementations configured to place limitations on the types and/or quantities of seeds used. According to embodiments, generative/training operations 165 can also pose other restrictions on crafting, such as certain seed items may get used up in the crafting process, resources must be expended to enable the crafting, or the crafting process may take time and tie up resources while in progress. Unlike traditional in-game crafting systems that require deterministic logic to enable the creation of a predetermined set of in-game objects from predetermined resources, generative/training operations 165 can enable the creation of an unlimited set of new unique content, which can make an in-game crafting system more exciting and fun. Generative/training operations 165 and content crafting may be configured to function more like cross breeding plants or animals where the offspring will have characteristics from the parents, but it is not deterministic as to what the result will be.

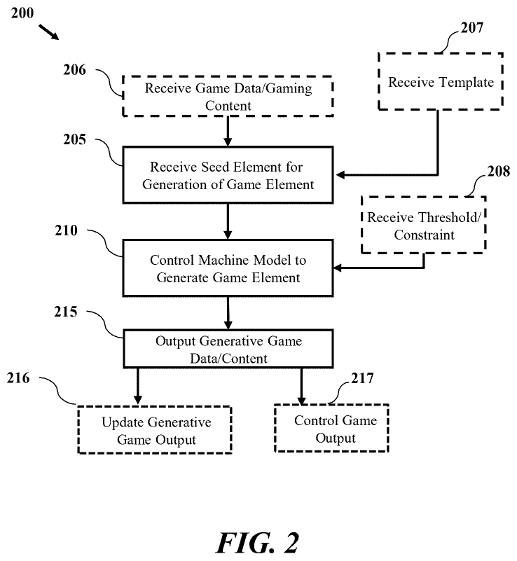

Process 150 may be performed in response to user control input 170 including a command to generate a game element. Generative/training operations 165 may be operations of a machine model and may be performed to generate crafted object 175. According to embodiments, crafted object may relate to a game object that may be used and/or presented during a game. By way of example, a crafted object may relate to a tool or weapon a character may use. Crafted object 175 may include the visual appearance of the object including graphical data for presentation with electronic game data. In additional to the visual representation, crafted object 175 may be generated with code to allow for use of the crafted object by a console device (e.g., console device 105) to present the crafted element for a user. According to embodiments, generative content crafting may include performing one or more operations and processes discussed herein, such as process 200 of FIG. 2, and process 600 of FIG. 6.

According to embodiments, generative/training operations 165 crafting can produce content that is not deterministic when seeded with the same content. For example, generative/training operations 165 can derive various aspects from the seed content to use in constructing the crafted item, such as shape, color, texture, power, ability, sounds, personality, or movements. Randomization can be used by generative/training operations 165 to determine which aspects of the seed content are emphasized when creating the crafted item and how those aspects of the seed element are used. An aspect can be used directly in the creation of a crafted item and/or aspects based on the training data with similarity to the aspect can be used in the creation of the crafted item. For example, if the seed element is an axe, a first aspect of the axe such as the shape and number of blades may be used, while a second aspect of the axe, such as the handle type, may not be used by generative/training operations 165 for crafted object 175.

Generative/training operations 165 can apply constraints on the items that it generates. Such constraints can be used to ensure that game balance of the electronic game is maintained, such as to prevent collected items from collecting all of the powers of the seed items over time, making the crafted items overpowered in-game. In some cases, generative/training operations 165 may be configured to use a point-based system to control the power of crafted items by assigning particular point values to different powers, abilities, or characteristics and then limiting the overall point value for the crafted item. For more powerful item, more resources may be required for crafting the item. In some cases, constraints can be used to reduce the chances that the generated content may be considered to be offensive, such as to analyze a creation for offensive potential and filter out any creation over a particular threshold. Such a constraint by generative/training operations 165 can be useful in a game title aimed at a younger audience. The generation of offensive content can be mitigated by curating the set of source material that generative/training operations 165 is trained on to not include content that is considered offensive.

According to embodiments, generative/training operations 165 can create an item that is part of a set of collectable items. In some cases, each generated item is unique. Similarly, each generated item is one which has not been crafted for a first user before, but the same item can be generated again when crafted by a second player.

According to embodiments, generative/training operations 165 can include adding and/or modifying elements to game areas, such as game areas of display 120. When generated, crafted content may be added to game areas, game structure, and the arrangement and order of game areas.

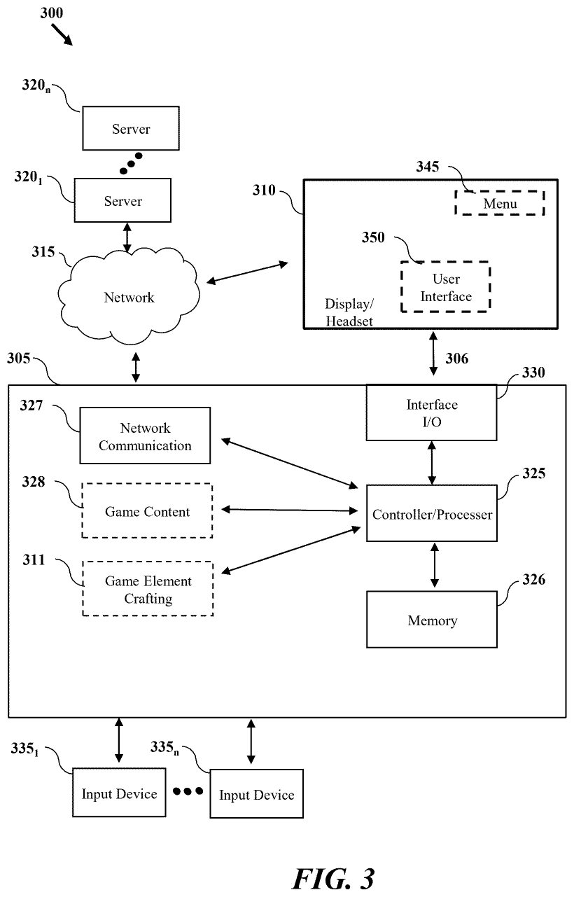

FIG. 2 illustrates a process for generative content crafting for an electronic game according to one or more embodiments. Process 200 may be configured to generate one or more elements or configurations for electronic games, including configuration of one or more existing elements of game elements and generating one or more new game elements and game areas. Process 200 may be performed by a device, such as device 305 and/or controller/processor 325 of FIG. 3, for generative content crafting.

Process 200 may be initiated by a device (e.g., device 305) receiving at least one seed element (e.g., seed elements 160₁₋ₙ) and a user instruction (e.g., control input 170) for generation of a game element at block 205. According to embodiments, the seed element includes a user description of a game element to be generated. Seed elements may relate to one or more input parameters provided by a user for content crafting. Seed elements may each include a user description or characteristic of a game element to be generated. Seed elements may include at least one of text, audio, graphical, video and in game input. Seed elements may be used in combination with one or more of game element(s) and control input for generation of a game element. Receiving at least one seed element at block 205 may include receiving a plurality of seed elements. Receiving at least one seed element at block 205 may also include receiving a user instruction identifying a game feature of the electronic game to be modified.

Process 200 may optionally include receiving game data/gaming content at block 206. Gaming data may include game elements, such as tools, weapons, characters and gameplay data including environment types, themes and colors user. Different games may include different gameplay styles and types of elements that fit within the game. For example a racing game may be mobiles. Game data may be used to assist with content crafting such that the elements are created fit within the game and the game design. With reference to the example of a racing game, generation of a boat could be restricted. Generation of a vehicle based on a user seed element may take one or more characteristics of the user seed element to generate a vehicle for the game. By way of further example, a user seed element including a car type, color and vehicle feature may result in one or more of these elements being integrated into a new vehicle with the same (or similar) car type, color and/or vehicle feature. Seed elements can be a text or audio description of the tool to be created and function of the tool. Embodiments including training a model based on in game elements to determine elements (visual) and configuration (functionality) for use in game. Content production may be performed to fit one or more aesthetics and game title elements. Crafted elements may be for more than just tools, including but not limited to modifying the appearance of a player controlled character, background and/or gaming element. Crafted elements may be modification of game elements of an electronic game to provide modification of character appearance, shape, and size.

Process 200 may be performed on electronic games (e.g., video games, interactive games, etc.). Electronic games may include one or more player controlled elements, a visual display or one or more levels or areas, and the ability of the user to control the character relative to one or more levels and areas. Electronic games may also include non-player elements such as non-player characters or playable game areas (e.g., routes), non-playable game areas, and various forms of displays.

Process 200 may optionally include receiving a template at block 207 including one or more data parameters and code plugins that allow for generating crafter elements to comport with processing of a game. Display games may require game elements to include a visual appearance, size and/or zones of interaction with other game elements. A machine model may be controlled to use at least one game element template and the game element template may be selected based on the seed element. The game element template may include at least one field description, each field description of the template providing a characteristics for generating the crafted element. Received templates may be used by process 200 to configured characteristic of a received seed element into code that may be used as part of the electronic game. Templates received may include one or more fields and data constraints to allow elements to be generated. Templates may be for tools (e.g., elements a character can use within the game), characters, character features and environment including background. At block 210, generative content crafting may be based on one or more received templates to create particular forms of content, such as a hat, outfit, decoration, trophy, sword, armor, creature, music, sound effect, blessing, training, or potion. Such a template would provide a framework to ensure that the generated object can be used for a particular purpose, such as to allow the item to be equipped in a game. Different crafted items can be usable for different purposes by an electronic game. In some cases, one or more templates for generated items can be derived from the seeds used to initiate the crafting.

At block 210, process 200 includes controlling a machine model for game element generation using the at least one seed element. The machine model is controlled to generate a crafted game element using one or more characteristics of the seed element. For example, if the seed element is a spoke or text description of a tool, such as an audio input or text string to build an axe with double blades. The machine model may detect and determine the characteristics of the seed element to use. The machine model in this example may generate a visual representation of an axe tool as a game element. Generation of elements may be based on machine models for generation of a visual component using the input from a user as input to the machine model for generation. According to embodiments, multiple seed elements may be detected and the type of seeds elements may be different. Controlling the machine model includes generating the crafted game element based on at least one characteristic of each seed element. With further regard to the example above, a user may provide an image of an axe including a single blade as a seed element. The machine model may combine features of the seed elements to arrive at a generated element. The text description of a double blade and the image provided may then generate an axe appearing visibly similar to the image provided and including double blades in this example. Machine model generation may include generation of elements that fit a game aesthetic, such that the machine model is trained on game elements and the appearance of game elements.

At optional block 208, process 200 may include receiving at least one threshold and/or constraint for content generation. According to embodiments, particular aspects of generative operations for content crafted items may be limited to have the generative operations create items that fit into a particular style or aesthetic, which can result in items that fit in with a particular game title, game area, or collection of content. For example, a different style can be used for underground elements of a game, such as using darker colors and more earth tones for the crafter elements. Other aspects can be consistent across the whole game title, such as applying a medieval castle theme to the whole game. Other elements generated by generative operations can be consistent within an area or across a game title can include such that the machine model is controlled to generate at least one craft element using the seed element based on at least one of a color temperature, color pallet, time period, drawing or rendering style (e.g., drawing style), game function, available technology, or highlighting to indicate certain things—such as to indicate an item that can be interacted with.

According to embodiments, process 200 includes a machine model controlled to generate a visual component of the generated craft element and a functional component of the generated craft element. The machine model may be controlled to generate at least one craft element using the seed element including detecting visual elements of the electronic game by the machine model, determining a visual style of the visual elements, generating a visual parameter for the craft element using the visual style determined by the machine model and applying at least one constraint to the crafted element. The visual component may provide the appearance of the element for one or more perspectives and game environments. The functional component may include game code for use including the characteristics, abilities and functions that may be incorporated with an electronic game. Electronic game data may be used by the machine model to inform abilities of game elements. The generated craft element is generated for use by the electronic game for presentation during game play and may be used for export to other devices.

According to embodiments, generative operations may only impose uniqueness for items crafted by a particular user and can allow the same item to be crafted by multiple users. If a player generates a new unique piece of content, such as a first item, using a generative operations and machine model crafting system, that player may be allowed to do various things with the first item, such as use it in game, put it in a display area or profile to show it off, gift it, trade it, lend it, sell it, or export it for use outside of the game. The player may be limited to just using the first item in the game instance or game world instance in which it was created. The player may be permitted to use the first item in multiple game instances in which they play, in which case the first item may be limited to being used in one game instance at a time or may be limited to being used only once in a particular game instance. Crafted content can be made available to or provide an advantage to a group of players, such as a guild within a game.

According to embodiments, if a player generates a new unique piece of content, such as a first item, using generative operations, that player may be considered to have discovered a recipe to create the item. Such a recipe can be used by the player to create more instances of the item that are identical to the original. Such a recipe may require the same set of components that were used to create the first instance of the item when it is used again, or may require the same types of components, but not identical components, especially if the crafting used a unique item to generate the new content. If the game has an in-game marketplace, then a player who discovers a recipe for a desirable item can craft copies of the item and sell them in the marketplace to earn in-game currency.

Items or recipes created by generative operations and content crafting may be used in various ways other than direct use by the creator, such as to share, sell, gift, lease, license, post online, or export the creation. In some cases, restrictions can be placed by the machine model on a transfer or grant of use to another, such as limitations to how and/or when the transfer can be used. In some cases, a grant of use to another can be limited to a particular time frame by the machine model. In some cases, a transfer or grant may be made to an entity other than another individual, such as to an NPS or a collection of others—such as a guild. In some cases, an item generated in a first gaming title can be used in a second gaming title, such as through adding an item generated in the first gaming title to a player profile that is then used in the second game title, allowing the player to use the item in the second gaming title. In some cases, items that are crafted in-game can be exported and used out-of-game, such as for an avatar, as a background, or in a social media post. In some cases, a non-fungible token (e.g., NFT), watermark, certificate of ownership or authenticity, or registration to an owner can be generated for an item that is crafted using generative AI crafting.

At block 215, process 200 includes outputting, by the device, the crafted game element for the electronic game. Outputting the crafted game element can include presentation of the crafted game element during a session of the electronic game. Presentation can include use of the crafted game element with the electronic game, such that one or more game elements, including user controlled elements and other players may interact with the crafted content. According to embodiments, output of the crafted game element may be limited. Content created through a generative operations may be limited to being used within the ecosystem, such as a game title, in which the crafting system is embedded. In some cases, the content crafted through a generative operations can be exported from the ecosystem in which it is embedded, such as a crafting tool, to allow the crafted content to be used in other places.

At block 216, process 200 may optionally include updated generative game output. Embodiments may include updating crafted content to modify, share and/or terminate the crafted content. Updating at optional block 216 may be based on use of the crafted element. Modification may be performed to improve game use, such as game functions based on the underlying code of the crafted content. Termination may be based on the crafted content being offensive, against game policy and/or based on user feedback (e.g., complaints, etc.).

At block 217, process 200 may optionally include controlling game output. Control of game output may be performed to allow for use of the crafted content and can include controlling game elements and game code in response to the crafted content. According to embodiments, an electronic game can group players together based on how they use generative operations or interact with items created by generative operations. For example, a player may get an invitation to a particular in-game guild or academy if they use generative operations or crafted items in particular ways. The electronic game may create a new group if it notices a new behavior pattern across a set of players. At block 217, process 200 may include clustering players in the electronic game based on at least one of use and characteristics of the crafted game element.

FIG. 3 illustrates a graphical representation of a system and device for generative content crafting according to one or more embodiments. According to embodiments, generative content crafting may be performed and used by a device or a system, such as a network gaming system. A system can include one or more components and devices. FIG. 3 illustrates system 300 according to embodiments which can include device 305. Device 305 may be one or more of a gaming console, computing device and electronic device in general configured to output gaming content 306 to display 310 and may include output of generated game worlds and electronic game content. With respect to gaming content, device 305 may be configured to output data for presentation by a display, or visual output device in general, including graphics (2D and 3D), sound and data. Device 305 may also be configured to output non-gaming content, such as video content, visual content, audio content, etc. Embodiments describe generative content crafting for electronic games and gaming, however it should be appreciated that the principles of the disclosure may be applied to other forms of media and non-gaming content. As such, device 305 and system 300 may be configured for generative operations that may be applied for one or more applications.

According to embodiments, device 305 is configured to output data 306 and/or content to display 310. According to embodiments, display 310 may be separate from or part of device 305. Device 305 may be configured for network communication by way of network 315 with one or more servers 320₁₋ₙ. Network communication can include one or more network communication type (e.g., Local Area Network (LAN), Metropolitan Area Network (MAN), Wide Area Network (WAN), Wireless, Inter Network (Internet). Device 305 may be configured to receive one or more of user data, game data and video data from servers 320₁₋ₙ. Servers 320₁₋ₙ may be configured to store one or more of user data, game data and generative data.

FIG. 3 depicts a device configuration according to embodiments. Device 305 may relate to a console, media device, and/or handheld device. Device 305 may be configured for generative content crafting for an electronic game. Device 305 may be configured to perform one or more processes described herein for generative content crafting. According to embodiments, device 305 includes controller 325, and memory 326. Device 305 may also include network communication module 327. Device 305 may also optionally include game content 328. Device 305 may optionally include a display 311 and/or may interoperate with display 310.

Controller 325 may relate to a processor or control device configured to execute one or more operations (e.g., executable instructions) stored in memory 326, such as processes for game world generation and game world population. Controller 305 may be coupled to memory 326, network communication module 327, and interface (I/O) 330. Memory 326 may be non-transitory memory configured to provide data storage and working memory operations for device 305. Memory 326 may be configured to store computer readable instructions for execution by controller 325 for one or more processes described herein. Network communication module 327 may be a communications module configured to receive and transmit network communication data.

According to embodiments, device 305 may be configured to receive at least one seed element and a user instruction for generation of a game element, wherein the seed element includes a user description of a game element to be generated. Device 305 may be configured to control a machine model for game element generation using the at least one seed element, wherein the machine model is controlled to generate a crafted game element. Device 305 may be configured to output the crafted game element for the electronic game.

According to embodiments, device 305 may be configured to receive game data for an electronic game, the game data including game data for at least one user of the electronic game. Device 305 may be configured to detect a crafted game element in the electronic game for the at least one user of the game, and to perform at least one evaluation operation for the crafted game element by the at least one user of the game. Device 305 may be configured to output a determination of the at least one evaluation operation.

Device 305 may be configured to receive gaming media (e.g., card, cartridge, disk, code, data, etc.) and output visual and audio content of the gaming media to display 310. Device 305 may be configured to receive data from one or more of servers 320₁₋ₙ to present and output game content 328, which may be stored in memory 326. For network games, device 305 may receive game data from a network source, such as servers 320₁₋ₙ, and may be configured to generate gaming music for the game data. Device 305 may similarly be configured to receive video content in general, including non-network game data, and output video content.

Device 305 may be configured to receive input from one or more peripheral devices, such as input devices 335₁₋ₙ. Input devices 335₁₋ₙ may be controllers or input devices in general configured to provide controls for device 305 and game control.

System 300 may include display 310 for output of visual and audio of an electronic game and/or output of device 305. According to embodiments, display 310 may display control elements of device 305, such as optional menu 350, which may be used to interface with device 305. Display 310 may output user interface 350 received from device 305. Device 300 may utilize one or more operations of processes described herein. It should also be appreciated that system 300 and its components may be configured to perform operations of device 305.

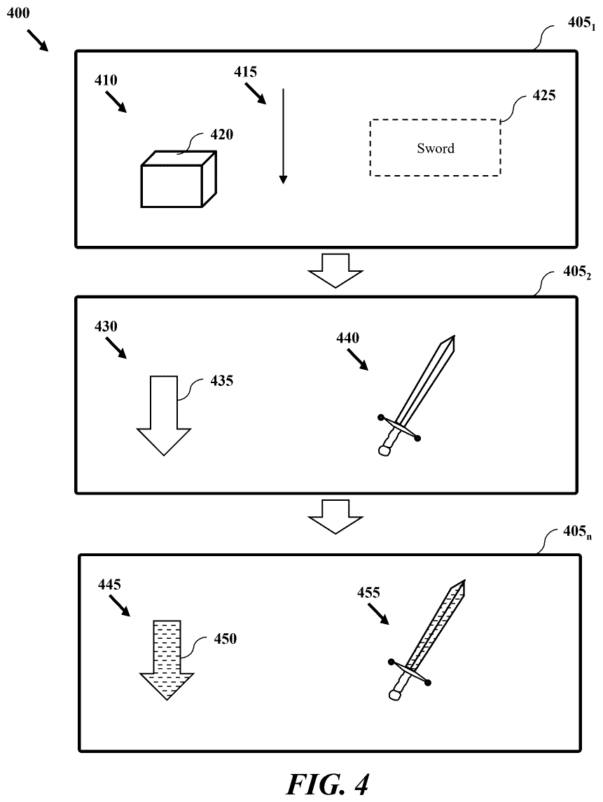

FIG. 4 illustrates a graphical representation of generative content crafting according to one or more embodiments. According to embodiments, process 400 for content crafting includes performing content crafting training for a model and generating elements for an electronic game using the machine model. In contrast to running a preprogrammed series of events or stages, embodiments provide operations and device configurations to generate one or more game elements, such as a game area, game object, game theme, etc. for an electronic game using at least one model. Training models may be configured to identify parameters from input, such as features of an electronic game, and generate one or more of configurations for the electronic game including configurations that are not preprogrammed. Game world population may include configuring preprogrammed elements, such as applying themes, however, it should be appreciated that generative content crafting may include generation of new elements and/or areas in addition to and/or separate from preprogrammed electronic game data.

According to embodiments, process 400 can include operation 405₁ for receiving game content 410 including one or more of data for game character(s), data for game area(s), data for game object(s) and data for one or more game themes. Operation 405₁ of process 400 can also receive at least one seed element, such as seed elements 415, 420 and 425. Based on received seed elements process 400 may perform one or more generative and/or training operations 405₁₋ₙ. According to embodiments, training operations may be performed to train a generative game model to craft one or more of a character, game area, game object and game theme. Training operations may include identifying one or more game standards using one or more of game character(s), data for game area(s), data for game object(s) and data for one or more game themes. Game standards may include one or more functional limitations. For example, a game standard may limit the control movements of a game object. Game standards may have design themes or display characteristics. For example, a game standard may limit the amount of background elements for a game area. Generative operations may include generating one or more of a character, game area, game object and game theme.

According to embodiments, generative content crafting may include using characteristics of one or more seed elements. Seed element 415 includes a down arrow, seed element 420 includes a three-dimensional shape and seed element 425 includes the word sword. Seed elements 415, 420 and 425 may be provided by a user by way of a user interface of an electronic game and detected by machine operations. According to embodiments, a machine model may detect features of the seed elements. Process 400 is an example of a combination and it should be appreciated that the example does not limit the ability to combine features of seed elements. Seed elements 415, 420 and 425 are merely examples representing the principles of the embodiments. At operation 405₂ of process 400, seed elements 415 and 420 may be combined to form crafted content 430. By way of example, a machine model make take the appearance or three-dimensional characteristic of seed element 420 to modify the down arrow of seed element 415 to generate game element 435. According to embodiments, operation 405₂ of process 400 may include conversion of the seed element 425 for sword, which may be provided as text, an image or audio (e.g., spoken) and generate game element 440. Process 400 may be iterative and features of the electronic game may be used to modify and/or generated crafted content. Operation 405₃ of process 400 includes modifying the appearance of generated game element 435 and generated game element 440 to generate crafted content 445. Crafted content 445 may include crafted game element 450 and crafted game element 455, wherein each of the elements includes a visual attribute that is applied based on the appearance and/or style of game elements for an electronic game. Generation and combination of features may be based on weighting the functions and appearance of game elements and the ability of the game to provide features that can be used in the game.

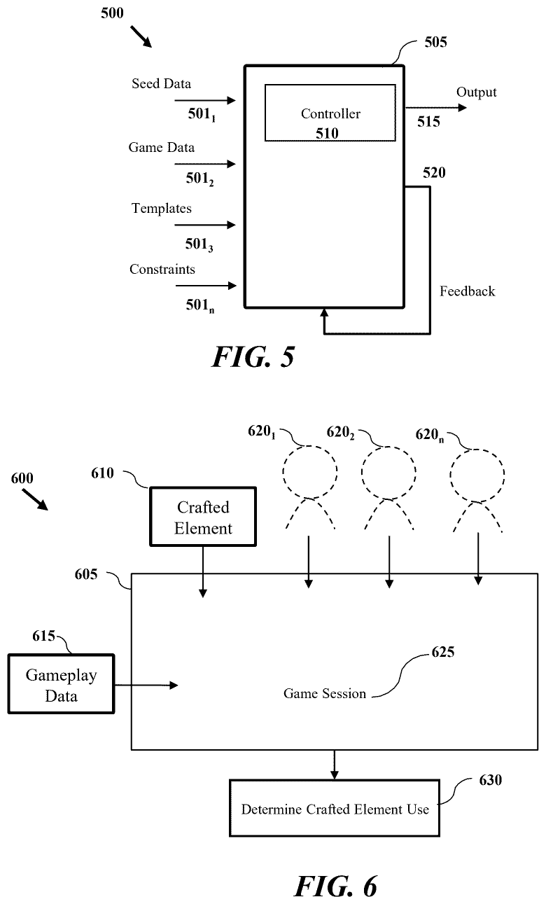

FIG. 5 illustrates a graphical representation of generative content crafting training according to one or more embodiments. According to embodiments, generative content crafting and evaluation may be performed using one or more references and models. Contextual information for objects, object function and object appearance may be determined based on a training process. Similarly, game function, use of the crafted game element and decision making for terminating (e.g., deleting) crafted content may be based on a training process. FIG. 5 illustrates training process 500 which can include receiving training input 501₁₋ₙ by a device 505 including a controller 510. According to embodiments, controller 510 may receive a plurality of gameplay videos and/or electronic game data for an electronic game as training input 501₁₋ₙ. In embodiments, training input 501₁₋ₙ may relate to rendered video data for a particular electronic game and one or more additional electronic games. Training input 501₁₋ₙ can include one or more references for game elements, user feedback and operability of an electronic game with crafted content. Training input 501₁₋ₙ may include game engine data for one or more electronic games. By way of example, training input 501₁₋ₙ can include seed data 501₁, game data 501₂, templates 501₃, and constraints 501ₙ. Based on the training in process 500, controller 510 may generate output 515. Output 515 may include one or more determined objects, game areas, game storylines, electronic game modifications, new characters, character speech and elements for populating game worlds. According to embodiments, controller 510 may be configured to generate output 515 based on a recursive loop including training and feedback. Feedback loop 520 may provide information such as ratings and accuracy for output 515.

According to embodiments, training process 500 and controller 510 may be configured to use one or more learning models (e.g., artificial intelligence, iterative models, etc.) to recognize objects and elements in an electronic game. Training process 500 and controller 510 may use one or more libraries of common electronic game objects, including object images and object descriptions.

According to embodiments, process 500 ma y be used for training and generative operations. Generative operations can be trained with content that is curated to be a good fit for the game environment. For example, for a crafting system in an adventure game set in a medieval setting would not be trained on content depicting modern objects such as telephones and cars that would be out of place in such a game setting. In some cases, generative operations may be trained with the game artwork and predefined objects. Using game objects may provide a basis for creations to appear to feel like they fit in the game world. This can also result in the generative AI creating content that has similar functionality to existing in-game objects, thus preserving the balance of the game.

In some cases, the generative operations is trained with a library of artwork that is similar to the artwork used in the game but is not artwork that is directly used in the game. Such a library can have a similar art style, setting, or set of fantasy creatures depicted in it. This can give the generative operations a bigger range of styles and forms to use in its creation, leading to greater variety, while still creating content that seems like it fits in the game environment.

FIG. 6 illustrates a graphical representation of generative content crafting and player grouping according to one or more embodiments. According embodiments, devices and processes are provided for selecting one or more users (e.g., players of an electronic game) based on use of one or more crafted elements and user data in general. Process 600 may be performed by a device 605, based on crafted element 610. Gameplay data 615 may be received for an electronic game that may be associated with one or more users, such as users 620₁₋ₙ. According to embodiments, crafted element 610 may be provided to users 620₁₋ₙ. According to other embodiments, users 620₁₋ₙ may be selected based on crafted element 610 for a game session 625. According to embodiments process 600 may determine crafted element use at block 630 for crafted element 610. According to embodiments, processes and operations described herein may be performed by one or more control devices. Alternatively or in combination, processes and operations described herein may be performed by one or more servers.

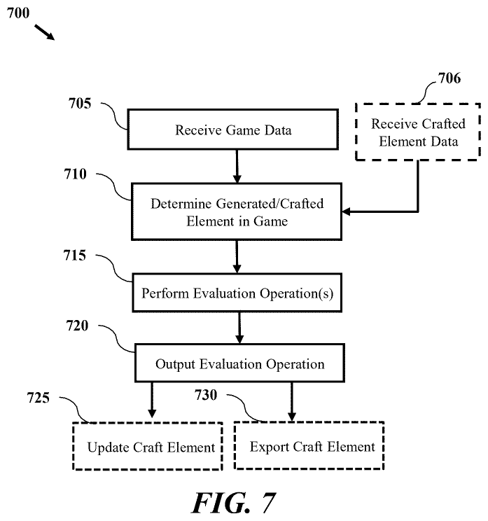

FIG. 7 illustrates a process for evaluating crafted content according to one or more embodiments. Process 700 may be configured to evaluate one or more crafted elements or configurations for electronic games, including a configuration of one or more existing elements of game elements and new game elements and game areas. Process 700 may be performed by a device, such as device 305 and/or controller 325 of FIG. 3, for evaluation of crafted content.

Process 700 maybe initiated with receiving game data for an electronic game at block 705. The game data can include game data for at least one user of the electronic game. Player gameplay data detected at block 705 may include user input controls, user commands (e.g., voice, user interface, etc.), user reactions and use of game elements electronic games. According to embodiments, detecting game data includes detecting in-game player interactions with elements of the electronic game. Detecting player data can include detecting input controls for a multiplayer game and identifying an in-game preferences for the at least one player of the electronic game. Receiving game data at block 705 for the electronic game can include receiving game data for instances of the crafted game element in the electronic game and user actions associated with the crafted game element.

Process 700 may optionally include receiving crafted element data at block 706. The crafted element data may include identification of crafted elements for one or more users to allow for detection of crafted elements in game data. Crafted game elements may be received based on a user profile and/or elements generated for an electronic game title associated with gameplay, the user, or a combination of both.

At block 710, process 700 includes detecting a crafted game element in the electronic game for the at least one user of the game. Detecting a crafted game element can include detecting a number of instances a crafted game element is presented, and a number of user actions associated with the crafted game element. Instances of the crafted game element may be based on game code, visual detection, discussion of the crafted content and transactions of the crafted content. According to embodiments, detecting a crafted game element includes detecting exchange of a crafted game element relative to the at least one user of the game and additional users of the electronic game.

At block 715, process 700 includes performing at least one evaluation operation for the crafted game element by the at least one user of the game. According to embodiments, performing the at least one evaluation includes detecting use of the crafted element for a plurality of users and comparing at least one attribute of the crafted element to elements of the electronic game. Performing the at least one evaluation can include evaluating behavior of the crafted element in the electronic game.

At block 720, process 700 includes output of one or more evaluation operations including outputting a determination of the at least one evaluation operation. Outputting the determination can include outputting the crafted game element outside of the electronic game. Outputting the determination can include outputting the crafted game element to at least one additional user of the electronic game.

Process 700 may optionally include modifying the crafted element based on the determination at block 725. Modifying the crafted element may include modifying at least one function, display characteristic and attribute of the crafted element. Modifying may include removal of the crafted element from the electronic game. Process 700 may optionally include exporting the crafted element at optional block 730. Exporting the crafted element can include sharing the element with one or more other users across a network.

Process 700 can learn from player preferences and/or observations of player gameplay to identify game elements that are engaging or enjoyable for the player. This information can be used by the generative operations to create game content that is customized for the player based on what the player finds engaging or enjoyable about game play and/or a game title. Generative operations can create new game elements by content customized to the player. Generative operations can populate a new game area for a player based on elements of other game areas that the player liked.

In some implementations, generative operations can learn from previous items that were crafted to improve the items that it crafts going forward. For example, if an item crafted by generative operations gets used a lot in play or is sold for a high price then processes and machine models performed by devices according to embodiments can infer that the item was desirable and learn from that as a good example of a crafted item. Similarly, if a crafted item is not used, discarded, or does not sell well the machine model can infer that the crafted item is less desirable and learn from that as a bad example of a crafted item. In the case that the same crafted item is made available to multiple users, the aggregation of the interactions from all the users can be used to make inferences about the item. In some cases, the machine models can make inferences about which aspects of a crafted item are desirable or undesirable based on user interactions with the item.

While this disclosure has been particularly shown and described with references to exemplary embodiments thereof, it will be understood by those skilled in the art that various changes in form and details may be made therein without departing from the scope of the claimed embodiments.

What is claimed is:

1. A method for generative content crafting for an electronic game, the method comprising:
receiving, by a device, at least one seed element and a user instruction for generation of a game element, wherein the seed element includes a user description of a game element to be generated;
controlling, by the device, a machine model for game element generation using the at least one seed element, wherein the machine model is controlled to generate a crafted game element; and
outputting, by the device, the crafted game element for the electronic game.

2. The method of claim 1, wherein the seed element includes at least one of text, audio, graphical, video and in game input, and wherein the seed element is received by the device.

3. The method of claim 1, wherein receiving at least one seed element includes receiving a plurality of seed elements, and wherein controlling the machine model includes generating the crafted game element based on at least one characteristic of each seed element.

4. The method of claim 1, wherein the user instruction identifies a game feature of the electronic game to be modified.

5. The method of claim 1, wherein machine model is controlled to generate at least one craft element using the seed element based on at least one of a color temperature, color pallet, time period, drawing style and game function.

6. The method of claim 1, wherein the machine model is controlled to generate a visual component of the generated craft element and a functional component of the generated craft element, and wherein the generated craft element is generated for use by the electronic game for presentation during game play.

7. The method of claim 1, wherein the machine model is controlled to use at least one game element template, the game element template selected based on the seed element and the game element template including at least one field description, wherein each field description of the template providing a characteristics for generating the crafted element.

8. The method of claim 1, wherein the machine model is controlled to generate at least one craft element using the seed element including detecting visual elements of the electronic game by the machine model, determining a visual style of the visual elements, generating a visual parameter for the craft element using the visual style determined by the machine model and applying at least one constraint to the crafted element.

9. The method of claim 1, wherein outputting the crafted game element includes presentation of the crafted game element during a session of the electronic game, and wherein presentation includes use of the crafted game element with the electronic game.

10. The method of claim 1, further comprising clustering players in the electronic game based on at least one of use and characteristics of the crafted game element.

11. A device configured for generative content crafting for an electronic game, the device comprising:
an interface;
a memory storing executable instructions; and
a processor coupled to the interface and the memory, wherein the processor is configured to
receive at least one seed element and a user instruction for generation of a game element, wherein the seed element includes a user description of a game element to be generated,
control a machine model for game element generation using the at least one seed element, wherein the machine model is controlled to generate a crafted game element, and output the crafted game element for the electronic game.

12. The device of claim 11, wherein the seed element includes at least one of text, audio, graphical, video and in game input, and wherein the seed element is received by the device.

13. The device of claim 11, wherein receiving at least one seed element includes receiving a plurality of seed elements, and wherein controlling the machine model includes generating the crafted game element based on at least one characteristic of each seed element.

14. The device of claim 11, wherein the user instruction identifies a game feature of the electronic game to be modified.

15. The device of claim 11, wherein machine model is controlled to generate at least one craft element using the seed element based on at least one of a color temperature, color pallet, time period, drawing style and game function.

16. The device of claim 11, wherein the machine model is controlled to generate a visual component of the generated craft element and a functional component of the generated craft element, and wherein the generated craft element is generated for use by the electronic game for presentation during game play.

17. The device of claim 11, wherein the machine model is controlled to use at least one game element template, the game element template selected based on the seed element and the game element template including at least one field description, wherein each field description of the template providing a characteristics for generating the crafted element.

18. The device of claim 11, wherein the machine model is controlled to generate at least one craft element using the seed element including detecting visual elements of the electronic game by the machine model, determining a visual style of the visual elements, generating a visual parameter for the craft element using the visual style determined by the machine model and applying at least one constraint to the crafted element.

19. The device of claim 11, wherein outputting the crafted game element includes presentation of the crafted game element during a session of the electronic game, and wherein presentation includes use of the crafted game element with the electronic game.

20. The device of claim 11, wherein the processor is further configured to cluster players in the electronic game based on at least one of use and characteristics of the crafted game element.
